(19) United States
(12) Patent Application Publication
(10) Pub. No.: US 2022/0140422 A1
(43) Pub. Date: May 5, 2022

(54) SOLID-STATE BATTERY HAVING A HYBRID CAPACITOR MATERIAL WITH A METAL-ORGANIC FRAMEWORK

(71) Applicant: GM GLOBAL TECHNOLOGY OPERATIONS LLC, Detroit, MI (US)

(72) Inventors: Si CHEN, Shanghai (CN); Yong LU, Shanghai (CN); Meiyuan WU, Shanghai (CN); Haijing LIU, Shanghai (CN); Zhe LI, Shanghai (CN)

(73) Assignee: GM GLOBAL TECHNOLOGY OPERATIONS LLC, Detroit, MI (US)

(21) Appl. No.: 17/500,660

(22) Filed: Oct. 13, 2021

(30) Foreign Application Priority Data
Oct. 30, 2020 (CN) 2020111883850

(51) Int. Cl. H01M 12/02; H01M 10/0525; H01M 10/0585; H01G 11/06; H01G 11/56; H01G 11/50; H01G 11/46

(52) U.S. Cl. CPC H01M 12/02; H01M 10/0525; H01M 10/0585; H01G 11/46; H01G 11/56; H01G 11/50; H01G 11/06

(57) ABSTRACT

A solid-state electrochemical cell that cycles lithium ions is provide, where the electrochemical cell has an electrolyte layer in a solid-state or semi-solid state defining a first surface. A solid electrode having an electroactive material that defines a second surface is present. A hybrid capacitor material including a metal organic framework intermingled with solid-state electrolyte particles is disposed in at least one of the following: the solid electrode, an interfacial layer disposed between the first surface of the electrolyte and the second surface of the solid electrode, or both in the solid electrode and the interfacial layer.

### CROSS-REFERENCE TO RELATED APPLICATIONS

This application claims the benefit and priority of Chinese Application No. CN2020111883850, filed Oct. 30, 2020. The entire disclosure of the above application is incorporated herein by reference.

### INTRODUCTION

This section provides background information related to the present disclosure which is not necessarily prior art.

The present disclosure relates to lithium-ion electrochemical cells having high-energy and high-power densities. Such, capacitor-assisted hybrid lithium-ion electrochemical cells include a hybrid capacitor material that includes a metal organic framework intermingled with solid-state electrolyte particles disposed in at least one of the following: a solid electrode, an interfacial layer disposed between and coextensive with a solid state or semi-solid state electrolyte and the solid electrode, or both in the solid electrode and the interfacial layer.

High-energy density electrochemical cells, such as lithium-ion batteries can be used in a variety of consumer products and vehicles, such as hybrid or electric vehicles. Typical lithium-ion batteries comprise at least one positive electrode or cathode, at least one negative electrode or an anode, an electrolyte material, and a separator. A stack of lithium-ion battery cells may be electrically connected in an electrochemical device to increase overall output. Lithium-ion batteries operate by reversibly passing lithium ions between the negative electrode and the positive electrode. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. For example, solid-state batteries include a solid-state or semi-solid state electrolyte disposed between solid-state electrodes, where the electrolyte physically separates the electrodes and can serve as a separator and ionic conductor, so that a distinct separator is not required. Each of the negative and positive electrodes within a stack is connected to a current collector (typically a metal, such as copper foil for the anode and aluminum foil for the cathode). During battery usage, the current collectors associated with the two electrodes are connected by an external circuit that allows current generated by electrons to pass between the electrodes to compensate for transport of lithium ions.

The potential difference or voltage of a battery cell is determined by differences in chemical potentials (e.g., Fermi energy levels) between the electrodes. Under normal operating conditions, the potential difference between the electrodes achieves a maximum achievable value when the battery cell is fully charged and a minimum achievable value when the battery cell is fully discharged. The battery cell will discharge and the minimum achievable value will be obtained when the electrodes are connected to a load performing the desired function (e.g., electric motor) via an external circuit.

Lithium solid-state batteries have been considered as a promising candidate for the next-generation of energy storage because they avoid use of liquid electrolytes and provide performance advantages that potentially include a wide voltage window, having good stability against lithium, and enhanced safety. However, the power density and energy storage capacity of solid-state batteries are generally lower due to the limitations on ion transport, especially at ambient and low temperatures. Energy capacity or density is an amount of energy the battery can store with respect to its mass (watt-hours per kilogram (Wh/kg)). Power capacity or density is an amount of power that can be generated by the battery with respect to its mass (watts per kilogram (W/kg)). More specifically, establishing good contact between a solid electrolyte and solid electrode can be more challenging than in a battery with a liquid electrolyte and solid electrode. Thus, batteries that incorporate solid components may require high compressive pressures to maintain contact between components like the solid electrodes and solid-state electrolyte during battery operation. Furthermore, microscopic and macroscopic void spaces at surfaces between solid components may exist or arise over time after cycling, which may contribute to high interfacial impedance. Thus, it would be desirable to reduce interfacial impedance between electrodes and solid-state electrolyte in solid-state batteries. For example, it would be advantageous to develop high power capacitor assisted solid electrolyte lithium-ion cells, which along with having high power density and high energy density, also have cycle stability.

### SUMMARY

This section provides a general summary of the disclosure, and is not a comprehensive disclosure of its full scope or all of its features.

The present disclosure relates in certain aspects to a solid-state electrochemical cell that cycles lithium ions, the electrochemical cell including an electrolyte layer in a solid-state or semi-solid state defining a first surface. The solid-state electrochemical cell also includes a solid electrode including an electroactive material and defining a second surface. Further, the solid-state electrochemical cell includes a hybrid capacitor material including a metal organic framework intermingled with solid-state electrolyte particles. The hybrid capacitor material is disposed in at least one of the following: the solid electrode, an interfacial layer disposed between the first surface of the electrolyte layer and the second surface of the solid electrode, or both in the solid electrode and the interfacial layer.

In one aspect, the solid electrode is a positive electrode and includes a positive electroactive material selected from the group consisting of: LiCoO₂, LiNiₓMn_{y}Co_{1-x=y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof.

In one aspect, the solid electrode is a negative electrode and includes a negative electroactive material selected from the group consisting of: lithium metal, silicon, silicon oxide, silicon alloys, graphite, graphene, lithium titanium oxide (Li₄Ti₅O₁₂) and sodium titanium oxide (Na₄Ti₅O₁₂); vanadium oxide (V₂O₅), and iron sulfide (FeS), and combinations thereof.

In one aspect, the solid-state electrolyte layer includes a material selected from the group consisting of: Li₇La₃Zr₂O₁₂ (LLZO), LiₓLa_{y}TiO₃ where 0<x<1 and 0<y<1 (LLTO), Li₁₊ₓAl_{y}Ti_{2-y}PO₄ where 0<x<1 and 0<y<2 (LATP), Li₂₊ₓZn₁₋ₓGeO₄ where 0<x<1 (LISICON), Li₂P₀₂N (LIPON), LiₓLa_{2/3-x}TiO₃, Li₁₊ₓAlₓTi₂₋ₓ(PO₄)₃, Li₁₀GeP₂S₁₂, Li₂S-P₂S₅, Li₂S-P₂S₅MSₓ, Li₁₀GeP₂S₁₂ (LGPS), Li_{3.25}Ge_{0.25}P_{0.75}S₄ (thio-LISICON), Li_{3.4}S_{10.4}P_{0.6}S₄, Li₁₀GeP₂S_{11.7}O_{0.3}, Li₆PS₅X (lithium argyrodite, where X=Cl, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(S_{10.5}Ge_{0.5})P₂S₁₂, Li₁₀(Ge_{0.5}Sn_{0.5})P₂S₁₂, Li₁₀(Si_{0.5}Sn_{0.5})P₂S ₁₂, perovskite type (Li₃ₓLa_{2/3-x}TiO₃), NASICON type (LiTi₂(PO₄)₃), Li₁₊ₓAlₓTi₂₋ₓ(PO₄)₃ (LATP), Li₁₊ₓAlₓGe₂₋ₓ(PO₄)₃ (LAGP), Li₁₊ₓYₓZr₂₋ₓ(PO₄)₃ (LYZP), LISICON type (Li₁₄Zn(GeO₄)₄), garnet type (Li_{6.5}La₃Zr_{1.75}Te_{0.25}O₁₂), Li₃N, Li₇PN₄, LiSi₂N₃, LiBH₄, LiBH4-LiX (X′Cl, Br or I), LiNH2, Li2NH, LiBH4-LiNH2, Li3AlH6, LiI, Li2CdCl4, Li2MgCl4, Li2Cdl4, Li2ZnI4, Li3OCl, Li2B4O7, Li2O—B2O3—P2O5, polyvinyl alcohol (PVA)-H2SO4, PVA-H3PO4, LiCl/PVA, PVA-KOH PVdF-HFP/[EMIM][Tf2N]/zeolite, a polymer host selected from include polyethylene oxide (PEO) or polyethylene glycol (PEG), polypropylene oxide (PPO), polymethylmethacrylate (PMMA), polyacrylonitrile (PAN), polyvinylidene fluoride (PVDF), polyvinylidene fluoride-hexafluoropropylene (PVDF-HFP), polyvinyl chloride (PVC) and a lithium salt, an ionic liquid in combination with a metal oxide particle selected from aluminum oxide (Al₂O₃), silicon dioxide (SiO₂), and combinations thereof.

In one aspect, the interfacial layer has a thickness of greater than or equal to about 100 nm to less than or equal to about 50 micrometers.

In one aspect, the metal organic framework is selected from the group consisting of: ZIF-2 and ZIF-3 (Zn₂(Im)₄), ZIF-4 and ZIF-6 (Zn(Im)₂), ZIF-5 (Zn₃In₂(Im)₁₂), ZIF-11 and ZIF-7 (Zn(bIm)₂) (C₇H₆N₂.Zn.H₂O), ZIF-8 (C₈H₁₀N₄Zn), ZIF-9 (C₇H₆N₂.Co.H₂O), ZIF-11 (Zn[C₇HSN_{2]2}), ZIF-14 (Zn(eIm)₂), ZIF-67 (C₈H₁₀N₄Co), ZIF-68 (C_{7.06}H_{4.94}N_{3.53}O_{1.59}Zn_{0.71}), ZIF-90 (C₄₈H₃₆N₂₄O₁₂Zn₆), IR-MOF ((Zn₄O)⁶⁺), IR-MOF-16 (Zn₄O(TPDC)₃, TPDC=terphenyldicarboxylate, IRMOF-1 (Zn₄O(BDC)₃), IRMOF-3 (Zn₄O(BDC-NH₂)₃), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg₂(DOT)), IRMOF-74-II (Mg₂(DH₂PhDC)), IRMOF-74-III (Mg₂(DH₃PhDC)), HKUST-1 ([Cu₃(C₉H₃O₆)₂]ₙ), MIL-53 (Fe(OH)(BDC)), MIL-100 (Fe₃F(H₂O)₂O[(C₆H₃)-(CO₂)₃]₂.nH20), MIL-101 [Cr₃(O)x(bdc)₃(H₂O)2] (bdc=benzene-1,4-dicarboxylate, X=OH or F), UiO (with Zr₆O₄(OH)₄), UIO-66 (Zr₂₄O₁₂₀C₁₉₂H₉₆N₂₄), UIO-67 ([Zr₆O₄(OH)₄—. (bpdc)6][bpdc=biphenyldicarboxylate, O₂C(C₆H₄)₂CO₂]), UIO-68 (Zr₆O₄(OH)₄(C₂₀H₁₀O₆)₆(C₃H₇NO)(CH₂Cl₂)₃), CPL-1 ([Cu₂(pzdc)₂(L)]ₙ, C₁₆H₈N₆O₈Cu₂), CPL-2(C₂₂H₁₂N₆O₈Cu₂), CPL-5(C₂₄H₁₄N₆O₈Cu₂), biomolecular ligands and CD-MOFs, PCN-14 (C₂₇₀H₁₆₂Cu₁₈O₉₀), covalent organic frameworks (COFs), and combinations thereof.

In one aspect, the electrode is a negative electrode.

In one aspect, the metal organic framework is at least partially disposed on and covering exterior surfaces of the solid-state electrolyte particles of the hybrid capacitor material.

In one aspect, the solid-state electrolyte is at least partially disposed on and covering exterior surfaces of the metal organic framework of the hybrid capacitor material.

In one further aspect, the solid-state electrolyte is at least partially disposed inside pores of the metal organic framework of the hybrid capacitor material.

In certain aspects, the present disclosure relates to a solid-state electrochemical cell that cycles lithium ions. The electrochemical cell includes an electrolyte layer in a solid-state or semi-solid state. A first solid electrode is included that has a first polarity and includes a first electroactive material. A second solid electrode having a second polarity opposite to the first polarity is also present and includes a second electroactive material. A hybrid capacitor material is further included that has a metal organic framework intermingled with solid-state electrolyte particles. The hybrid capacitor material is disposed in at least one of the following: (i) the first solid electrode, (ii) a first interfacial layer disposed between the electrolyte layer and the first solid electrode, (iii) the second solid electrode, (iv) a second interfacial layer disposed between the electrolyte layer and the second solid electrode, or in any combination of (i)(iv).

In one aspect, the first solid electrode is a negative electrode and the first electroactive material includes a negative electroactive material selected from the group consisting of: lithium metal, silicon, silicon oxide, silicon alloys, graphite, graphene, lithium titanium oxide (Li₄Ti₅O₁₂) and sodium titanium oxide (Na₄Ti₅O₁₂), vanadium oxide (V₂O₅), and iron sulfide (FeS), and combinations thereof, and the second solid electrode is a positive electrode and the second electroactive material includes including includes a positive electroactive material selected from the group consisting of: LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof.

In one aspect, the solid-state electrolyte of the hybrid capacitor material includes a material selected from the group consisting of: Li₇La₃Zr₂O₁₂ (LLZO), LiₓLa_{y}TiO₃ where 0≤x≤1 and 0≤y≤1 (LLTO), Li₁₊ₓAl_{y}Ti_{2-y}PO₄ where 0≤x≤1 and 0≤y≤2 (LATP), Li₂₊₂ₓZn₁₋ₓGeO₄ where 0≤x≤1 (LISICON), Li₂PO₂N (LIPON), LiₓLa2/3_{—x}TiO3, Li₁₊ₓAlₓTi₂₋ₓ(PO₄)₃, Li₁₀GeP₂S₁₂, Li₂S-P₂S₅, Li₂S-P₂S₅-MSₓ, Li₁₀GeP₂S ₁₂ (LGPS), Li_{3.25}Ge_{0.25}P_{0.75}S₄ (thio-LIS ICON), Li_{3.4}Si_{0.4}P_{0.6}S₄, Li₁₀GeP₂S_{11.7}O_{0.3}, Li₆PS₅X (lithium argyrodite, where X=Cl, Br, or I), Li_{9.54}Si_{1.74}P_{1.44}S_{11.7}Cl_{0.3}, Li_{9.6}P₃S₁₂, Li₇P₃S₁₁, Li₉P₃S₉O_{3,}Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, perovskite type (Li₃ₓLa_{2/3-x}TiO₃), NASICON type (LiTi₂(PO₄)₃), Li₁₊ₓAlₓTi₂₋ₓ(PO₄)₃ (LATP), Li₁₊ₓAlₓGe₂₋ₓ (PO₄)₃ (LAGP), Li₁₊ₓYₓZr₂₋ₓ(PO₄)₃ (LYZP), LISICON type (Li₁₄Zn(GeO₄)₄), garnet type (Li_{6.5}La₃Zr_{1.75}Te_{0.25}O₁₂), Li₃N, Li₇PN₄, LiSi₂N₃, LiBH₄, LiBH_{4—}LiX (X=Cl, Br or I), LiNH₂, Li₂NH, LiBH_{4—}LiNH₂, Li₃AlH₆, LiI, Li₂CdCl₄, Li₂MgCl₄, Li₂CdI₄, Li₂ZnI₄, Li₃₀Cl, Li₂B₄O₇, Li₂O—B₂O₃—P₂O₅, polyvinyl alcohol (PVA)-H₂SO₄; PVA-H₃PO₃; LiCl/PVA; PVA-KOH; PVdF-HFP/[EMIM][Tf₂N]/zeolite, a polymer host selected from include polyethylene oxide (PEO) or polyethylene glycol (PEG), polypropylene oxide (PPO), polymethylmethacrylate (PMMA), polyacrylonitrile (PAN), polyvinylidene fluoride (PVDF), polyvinylidene fluoride-hexafluoropropylene (PVDF-HFP), polyvinyl chloride (PVC) and a lithium salt, an ionic liquid in combination with a metal oxide particle selected from aluminum oxide (Al₂O₃), silicon dioxide (SiO₂), and combinations thereof.

In one aspect, the metal organic framework of the hybrid capacitor material is selected from the group consisting of: ZIF-2 and ZIF-3 (Zn₂(Im)₄), ZIF-4 and ZIF-6 (Zn(Im)₂), ZIF-5 (Zn₃In₂(Im)₁₂), ZIF-11 and ZIF-7 (Zn(bIm)₂) (C₇H₆N₂.Zn.H₂O), ZIF-8 (C₈H₁₀N₄Zn), ZIF-9 (C₇H₆N₂.Co.H₂O), ZIF-11 (Zn[C₇H₅N_{2]2}), ZIF-14 (Zn(eIm)₂), ZIF-67 (C₈H₁₀N₄Co), ZIF-68 (C_{7.06}H_{4.94}N_{3.53}O_{1.59}Zn_{0.71}), ZIF-90 (C₄₈H₃₆N₂₄O₁₂Zn₆), IR-MOF ((Zn₄O)⁶⁺), 16 (Zn₄O(TPDC)₃, TPDC=terphenyldicarboxylate, IRMOF-1 (Zn₄O(BDC)₃), IRMOF-3 (Zn₄O(BDC-NH₂)₃), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg₂(DOT)), IRMOF-74-II (Mg₂(DH₂PhDC)), IRMOF-74-III (Mg₂(DH₃PhDC)), HKUST-1 ([Cu₃(C₉H₃O₆)₂]ₙ), MIL-53 (Fe(OH)(BDC)), MIL-100

(Fe₃F(H₂O)₂O[(C₆H₃)-(CO₂)_{3]2}.nH₂₀), MIL-101 [Cr₃(O)x(bdc)₃(H₂O)₂] (bdc=benzene-1,4-dicarboxylate, X=OH or F), UiO (with Zr₆O₄(OH)₄), UIO-66 (Zr₂₄O₁₂₀C₁₉₂H₉₆N₂₄), UIO-67 ([Zr₆O₄(OH)₄—.(bpdc)₆] [bpdc=biphenyldicarboxylate, O₂C(C₆H₄)₂CO₂]), UIO-68 (Zr₆O₄(OH)₄(C₂₀H₁₀O₆)₆(C₃H₇NO)(CH₂Cl₂)₃), CPL-1 ([CU₂(L)ZdC)2(L)]ₙ, C₁₆H₈N₆O₈Cu₂), CPL-2(C₂₂H₁₂N₆O₈Cu₂), CPL-5(C₂₄H₁₄N₆O₈Cu₂), biomolecular ligands and CD-MOFs, PCN-14 (C₂₇₀H₁₆₂Cu₁₈O₉₀), covalent organic frameworks (COFs), and combinations thereof.

The present disclosure further relates in certain aspects to a method of making a hybrid capacitor material for a solid-state electrochemical cell that cycles lithium ions. The method includes heating a precursor including a metal organic framework material, a solid-state electrolyte material and solvent to a temperature of greater than or equal to about 20 to less than or equal to about 85° C. for a period of greater than or equal to about 10 minutes to less than or equal to about 10 hours. The method also optionally includes removing the solvent to form a hybrid capacitor material including the metal organic framework having the solid-state electrolyte associated therewith.

In one aspect, after heating the precursor, the removing solvent includes vacuum drying the precursor at a temperature of greater than or equal to about 100° C. to less than or equal to about 300° C. for a period of greater than or equal to about 30 minutes to less than or equal to about 48 hours.

In one aspect, the heating of the precursor is to a temperature of about 80° C. for a period of greater than or equal to about 6 hours; and removing the solvent is vacuum drying is conducted at the temperature of about 150° C. for about 20 hours.

In one aspect, the metal organic framework is at least partially disposed on and covering exterior surfaces of the solid-state electrolyte particles.

In one aspect, the solid-state electrolyte is at least partially disposed on and covering surfaces of the exterior surfaces of the metal organic framework and the solid-state electrolyte is at least partially disposed inside pores of the metal organic framework.

In one aspect, the solid-state electrolyte of the hybrid capacitor material is selected from the group consisting of: Li₁₀GeP₂S₁₂, Li₂S-P₂S₅, Li₂S-P₂S₅-MSx, Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, Li₆PS₅X (lithium argyrodite, where X=Cl, Br, or I), Li_{9.54}Si_{1.74}P_{1.44}S_{11.7}Cl_{0.3}, Li_{9.6}P₃S₁₂, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, perovskite type (Li₃ₓLa_{2/3-x}TiO₃), NASICON type (LiTi₂(PO₄)₃), Li₁₊ₓAlₓTi₂₋ₓ(PO₄)₃ (LATP), Li₁₊ₓAlₓGe₂₋ₓ (PO₄)₃ (LAGP), Li₁₊ₓYₓZr₂₋ₓ(PO₄)₃ (LYZP), LISICON type (Li₁₄Zn(GeO₄)₄), garnet type (Li_{6.5}La₃Zr_{1.75}Te_{0.25}O₁₂), and combinations thereof and the metal organic framework of the hybrid capacitor material is selected from the group consisting of: ZIF-2 and ZIF-3 (Zn₂(Im)₄), ZIF-4 and ZIF-6 (Zn(Im)₂), ZIF-5 (Zn₃In₂(Im)₁₂), ZIF-11 and ZIF-7 (Zn(bIm)₂) (C₇H₆N₂.Zn.H₂O), ZIF-8 (C₈H₁₀N₄Zn), ZIF-9 (C₇H₆N₂.Co.H₂O), ZIF-11 (Zn[C₇H₅N₂]₂), ZIF-14 (Zn(eIm)₂), ZIF-67 (C₈H₁₀N₄Co), ZIF-68 (C_{7.06}H_{4.94}N_{3.53}O_{1.59}Zn_{0.71}), ZIF-90 (C₄₈H₃₆N₂₄O₁₂Zn₆), IR-MOF ((Zn₄O)⁶⁺), IR-MOF-16 (Zn₄O(TPDC)₃, TPDC=terphenyldicarboxylate, IRMOF-1 (Zn₄O(BDC)₃), IRMOF-3 (Zn₄O(BDC-NH₂)₃), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg2(DOT)), IRMOF-74-II (Mg₂(DH₂PhDC)), IRMOF-74-III (Mg₂(DH₃PhDC)), HKUST-1 ([Cu₃(C₉H₃O₆)₂]ₙ), MIL-53 (Fe(OH)(BDC)), MIL-100 (Fe₃F(H₂O)₂O[(C₆H₃)-(CO₂)₃]₂.nH₂O), MIL-101 [Cr₃(O)x(bdc)₃(H₂O)₂] (bdc=benzene-1,4-dicarboxylate, X=OH or F), UiO (with Zr₆O₄(OH)₄), UIO-66 (Zr₂₄O₁₂₀C₁₉₂H₉₆N₂₄), UIO-67 ([Zr₆O₄(OH)₄—. (bpdc)₆] [bpdc=biphenyldicarboxylate, O₂C(C₆H₄)₂CO₂]), UIO-68 (Zr₆O₄(OH)₄(C₂₀H₁₀O₆)₆(C₃H₇NO)(CH₂Cl₂)₃), CPL-1 ([Cn₂(pzde)₂(L)]ₙ, C₁₆H₈N₆O₈Cu₂), CPL-2(C₂₂H₁₂N₆O₈Cu₂), CPL-5(C₂₄H₁₄N₆O₈Cu₂), biomolecular ligands and CD-MOFs, PCN-14 (C₂₇₀H₁₆₂Cu₁₈O₉₀), covalent organic frameworks (COFs), and combinations thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 shows a schematic of a positive electrode and a negative electrode in an electrochemical capacitor incorporating a metal organic framework, where the magnified portion shows a metal organic framework having open pores with lithium ions adsorbing therethrough.

FIG. 2 shows a hybrid capacitor material prepared in accordance with certain other aspects of the present disclosure that includes a metal organic framework intermingled with solid-state electrolyte particles where exterior surfaces of a metal organic framework are at least partially disposed on and cover exterior surfaces of the solid-state electrolyte.

FIG. 3 shows a hybrid capacitor material prepared in accordance with certain aspects of the present disclosure that includes a metal organic framework intermingled with solid-state electrolyte particles where the solid-state electrolyte is at least partially disposed on and covering exterior surfaces of the metal organic framework and the solid state electrolyte particles are at least partially disposed inside pores of the metal organic framework.

FIGS. 4A-4F show lithium ion electrochemical cells having solid electrolytes prepared in accordance with certain variations of the present disclosure. FIG. 4A shows a hybrid capacitor material including a metal organic framework intermingled with solid-state electrolyte particles disposed in a negative electrode or anode. FIG. 4B shows the hybrid capacitor material disposed in a positive electrode or cathode. FIG. 4C shows the hybrid capacitor material disposed in both a negative electrode or anode and a positive electrode or cathode. FIG. 4D shows the hybrid capacitor material disposed in an interfacial layer between the solid electrolyte and the negative electrode or anode. FIG. 4E shows the hybrid capacitor material disposed in an interfacial layer between the solid electrolyte and a positive electrode or cathode. FIG. 4F shows a hybrid capacitor material disposed in an interfacial layer between the solid electrolyte and both a negative electrode or anode and a positive electrode or cathode.

FIG. 5 shows a bare metal organic framework (ZIF-67) precursor used to prepare the hybrid capacitor material in accordance with certain aspects of the present disclosure. Scale bar is 2 μm.

FIG. 6A-6F show a hybrid capacitor material including a metal organic framework (ZIF-67) intermingled with solid-state electrolyte particles (Li₆PS₅Cl or LPSCL) prepared in accordance with certain aspects of the present disclosure. FIG. 6A shows a scanning electron microscopy image of the hybrid capacitor material. The solid-state electrolyte particles (LPSCl) cover an external surface of the bare metal organic framework (ZIF-67). FIGS. 6B-6F show EDS mapping pictures of the marked region of FIG. 6A. FIG. 6B shows phosphorus (P) Kα1. FIG. 6C shows sulfur (S) Kα1. FIG. 6D shows chlorine (Cl) Kα1. FIG. 6E shows cobalt (Co) Kα1. FIG. 6F shows oxygen (0) Kα1. Scale bars are 10 μm in FIGS. 6A-6F.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

In various aspects, the present disclosure provides electrochemical cells that cycle lithium ions that include a hybrid capacitor material prepared in accordance with certain aspects of the present disclosure that includes a metal organic framework intermingled with solid-state electrolyte particles. As will be described further herein, such a hybrid capacitor material is particularly useful in solid-state batteries (SSB) that include solid electrodes and solid or semi-solid electrolytes. The hybrid capacitor material based on metal-organic frameworks (MOFs) enhance power density and cycle stability of solid state batteries due to their large surface areas, controllable pores, and nanocrystal structures. When the MOFs are composited or intermingled with solid electrolyte particles in accordance with certain aspects of the present disclosure, MOFs can function as a capacitor, and also can be considered to be a buffer pool for improving lithium-ion transfer in the solid-state battery. Such capacitor-assisted electrolytes can improve poor power performance issues often observed in solid state batteries (SSB). By incorporating the inventive hybrid capacitor material, safe SSBs having desirably high power may be formed, while maintaining intrinsic electrochemical characteristics of the SSB.

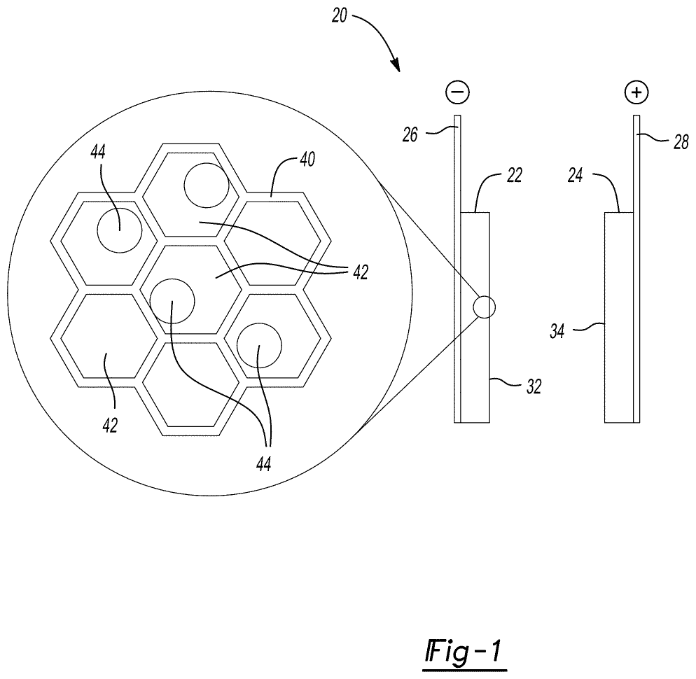

FIG. 1 shows a schematic of illustrative operating principles of an electrochemical capacitor 20 including a negative electrode 22 and a positive electrode 24. The negative electrode 22 is in electrical communication with a negative current collector 26. The positive electrode 24 is in electrical communication with a positive current collector 28. A metal organic framework (MOF) material 40 is disposed in a negative electrode 22. While not shown, a solid or semi-solid electrolyte layer may be disposed between the first surface 32 of the negative electrode 22 and the second surface 34 of the positive electrode 34.

In the magnified portion of FIG. 1, the metal organic framework 40 defines a plurality of open pores 42. Metal-organic frameworks (MOF) are hybrid, porous, crystalline solids that result from three-dimensional (3-D) covalent connections of inorganic clusters by using organic linkers. Internal pores include those formed on various surfaces of each metal-organic framework (MOF) structure, including both internal surfaces and potentially external or exposed surfaces. Thus, ions 44, such as lithium ions, can adsorb on the surface of open pores 42. In the negative electrode 22, there is fast adsorption of cations (e.g., lithium ions) during charging and desorption of cations in discharging the electrochemical cell. Thus, the presence of metal organic frameworks can enhance ion transport to and from the interfaces of the solid electrodes to the adjacent solid or semi-solid electrolyte.

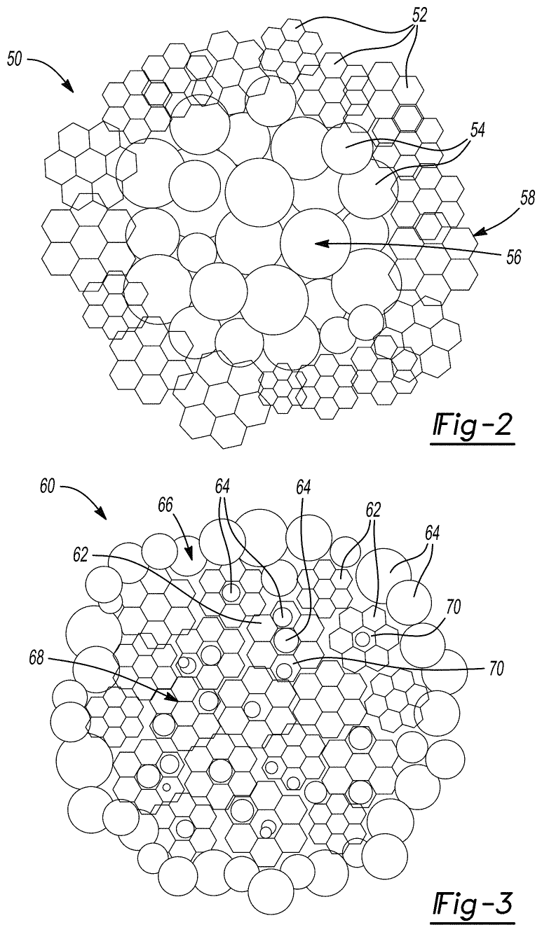

FIG. 2 shows a hybrid capacitor material 50 prepared in accordance with certain aspects of the present disclosure that includes a metal organic framework 52 intermingled or associated with solid-state electrolyte particles 54 to form an agglomerated structure. An exterior surface of metal organic framework 52 is optionally at least partially disposed on and covering surfaces of the solid state electrolyte particles 54. The solid state electrolyte particles 54 may define a core region 56, while the metal organic framework particles define a shell region 58 disposed around the core region 56. In this variation, the metal organic framework particles 52 cover a surface of the solid state electrolyte particles 54. It should be noted that in this embodiment, an average particle size diameter of the solid state electrolyte particles 54 may be greater than an average particle size diameter of the metal organic framework particles 52. Metal organic framework particles and pore sizes can be highly controlled during synthesis to form the desired dimensions for a given application.

FIG. 3 shows yet another variation of a hybrid capacitor material 60 prepared in accordance with certain other aspects of the present disclosure that includes a metal organic framework 62 intermingled or associated with solid-state electrolyte particles 64 to form an agglomerated structure. The solid state electrolyte particles 64 are disposed on an exterior surface of the metal organic framework 62 and thus the solid state electrolyte particles 64 define a shell region 66, while the metal organic framework 62 defines a core region 68. It should be noted that in this embodiment, a particle size diameter of at least a portion of the solid state electrolyte particles 64 may be less than an average particle size diameter of the metal organic framework particles 62 and in particular less than a pore size of at least a portion of the metal organic framework particles 62. In this manner, the solid-state electrolyte 64 is at least partially disposed inside pores 70 of the metal organic framework 62. In this variation, the solid state electrolyte particles 64 may be considered to be wrapped about the exterior surface(s) of the metal organic framework 62 and some of the solid state electrolyte particles 64 may further enter into the pores of the metal organic framework 62. The hybrid capacitor material may have an electrical conductivity of greater than or equal to about 1×10⁻⁶S/cm to less than or equal to about 1×10⁻²S/cm. A surface area (measure by SBET) of the metal organic framework 62 may be greater than or equal to about 1,000 m²/g to less than or equal to about 2,000 m²/g. The solid state electrolyte particles 64 may cover greater than or equal to about 1% to less than or equal to about 40% of surface area of the metal organic framework 62. As referred to herein, a hybrid capacitor material includes either of the variations described in FIG. 2 or 3.

Suitable metal organic framework material may have a high regular porosity with different pore shapes and sizes. As noted above, MOF characteristics like porosity, pore size, and overall particle diameter can be highly tunable. In certain aspects, an average pore diameter may be greater than or equal to about 3 Å (Angstrom) to less than or equal to about 1 and in certain variations, an average pore diameter of less than or equal to about 500 nm is selected.

In certain variations, the metal organic framework may comprise heterocyclic ligands containing nitrogen, such as a zeolitic imidazole framework (ZIF), including by way of example, ZIF-2 and ZIF-3 (Zn₂(Im)₄), ZIF-4 and ZIF-6 (Zn(Im)₂), ZIF-5 (Zn₃In₂(Im)₁₂), ZIF-11 and ZIF-7 (Zn(bIm)₂) (C₇H₆N₂.Zn.H₂O), ZIF-8 (C₈H₁₀N₄Zn), ZIF-9 (C₇H₆N₂.Co.H₂O), ZIF-11 (Zn[C₇HSN₂]₂), ZIF-14 (Zn(eIm)₂), ZIF-67 (C₈H₁₀N₄Co), ZIF-68 (C_{7.06}H_{4.94}N_{3.53}O_{1.59}Zn_{0.71}), ZIF-90 (C₄₈H₃₆N₂₄O₁₂Zn₆), and the like. The metal organic framework may comprise carboxylic acid ligands, such as IR-MOF (with the same topology, (Zn₄O)⁶⁺), such as IRMOF-16 (Zn₄O(TPDC)₃, TPDC=terphenyldicarboxylate), IRMOF-1 (Zn₄O(BDC)₃), IRMOF-3 (Zn₄O(BDC-NH₂)₃), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg₂(DOT)), IRMOF-74-II (Mg₂(DH₂PhDC)), (Mg₂(DH₃PhDC)), and the like. Other suitable metal organic framework particles include HKUST, such as HKUST-1 ([Cu₃(C₉H₃O₆)₂]ₙ), MIL, such as MIL-53 (Fe(OH)(BDC)), MIL-100 (Fe₃F(H₂O)₂O[(C₆H₃)-(CO₂)₃]₂.nH₂O), MIL-101 [Cr₃(O)x(bdc)₃(H₂O)₂] (bdc=benzene-1,4-dicarboxylate, X=OH or F), and the like. Yet other suitable metal organic frameworks include UiO (with Zr₆O₄(OH)₄), such as UIO-66 (Zr₂₄O₁₂₀Cl₉₂H₉₆N₂₄), UIO-67 ([Zr₆O₄(OH)₄—. (bpdc)₆] [bpdc=biphenyldicarboxylate, O₂C(C₆H₄)₂CO₂]), UIO-68 (Zr₆O₄(OH)₄(C₂₀H₁₀O₆)₆(C₃H₇NO)(CH₂Cl₂)₃), and the like or CPL, such as CPL-1 ([Cu₂(pzdc)₂(L)]ₙ, C₁₆H₈N₆O₈Cu₂), CPL-2(C₂₂H₁i₂N₆O₈Cu₂), CPL-5(C₂₄H₁₄N₆O₈Cu₂), and the like. Yet other metal organic frameworks include biomolecular ligands and CD-MOFs, PCN-14 (C₂₇₀H₁₆₂Cu₁₈O₉₀), and covalent organic frameworks (COFs). Any combinations of these metal organic frameworks may also be used. In one variation, the metal organic framework comprises ZIF-67 (C₈H₁₀N₄Co).

In certain variations, the solid state electrolyte may be sulfide-based, such as Li₂S—P₂S₅, Li₂S—P₂S_{5—}MSₓ, LGPS (Li₁₀GeP₂S₁₂), thio-LISICON (Li_{3.25}Ge_{0.25}P_{0.75}S₄), Li_{3.4}Si_{0.4}P_{0.6}S₄, Li₁₀GeP₂S_{11.7}O_{0.3}, lithium argyrodite Li₆PS₅X (where X=Cl, Br, or I), Li_{9.54}Si_{1.74}P_{1.44}S_{11.7}Cl_{0.3} (25 mS/cm), Li_{9.6}P₃S₁₂, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Sia₅Ge_{0.5})P₂S₁₂, Li₁₀(Ge_{0.5}Sn_{0.5})P₂S₁₂, Li₁₀(Si_{0.5}Sn_{0.5})P₂S₁₂. The sulfide-based solid state electrolyte may have an ionic conductivity of greater than or equal to aabout 10⁻⁷ to less than or equal to about 10⁻² S/cm. The solid state electrolyte may be an oxide-based solid electrolyte, such as a perovskite type (Li₃ₓLa_{2/3-x}TiO₃), NASICON type (LiTi₂(PO₄)₃), Li₁₊ₓAlₓTi₂₋ₓ(PO₄)₃ (LATP), Li₁₊ₓAlₓGe₂₋ₓ (PO₄)₃ (LAGP), Li₁₊ₓYₓZr₂₋ₓ(PO₄)₃ (LYZP), LISICON type (Li₁₄Zn(GeO₄)₄), Garnet type (Li_{6.5}La₃Zr_{1.75}Te_{0.25}O₁₂), and the like. The oxide-based solid state electrolyte may have an ionic conductivity of greater than or equal to aabout 10⁻⁵ to less than or equal to about 10⁻³ S/cm.

In other variations, the solid-state electrolyte may be a polymer based solid electrolyte, where the polymer host together with a lithium salt act as a solid solvent. The polymer may include polyethylene oxide (PEO) or polyethylene glycol (PEG), polypropylene oxide (PPO), polymethylmethacrylate (PMMA), polyacrylonitrile (PAN), polyvinylidene fluoride (PVDF), polyvinylidene fluoride-hexafluoropropylene (PVDF-HFP), polyvinyl chloride (PVC). Appropriate lithium salts generally include inert anions. A non-limiting list of lithium salts that may be dissolved in an organic solvent or a mixture of organic solvents to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium difluorooxalatoborate (LiBF₂(C₂O₄)) (LiODFB), lithium tetraphenylborate (LiB(C₆H₅)₄), lithium bis-(oxalate)borate (LiB (C₂O₄)₂) (LiBOB), lithium tetrafluorooxalatophosphate (LiPF₄(C₂O₄)) (LiFOP), lithium nitrate (LiNO₃), lithium hexafluoroarsenate (LiAsF₆), lithium trifluoromethanesulfonate (LiCF₃SO₃), lithium bis(trifluoromethanesulfonimide) (LiTFSI) (LiN(CF₃SO₂)₂), lithium fluorosulfonylimide (LiN(FSO₂)₂) (LiFSI), and combinations thereof. In certain variations, the lithium salt is selected from lithium hexafluorophosphate (LiPF₆), lithium bis(trifluoromethanesulfonimide) (LiTFSI) (LiN(CF₃SO₂)₂), lithium fluorosulfonylimide (LiN(FSO₂)₂) (LiFSI), and combinations thereof. The solid state electrolyte may have an ionic conductivity at a magnitude of 10⁴ S/cm.

In yet other variations, the solid-state electrolyte may be a nitride-based solid electrolyte, such as Li₃N, Li₇PN₄, LiSi₂N₃ and the like. The nitride-based solid state electrolyte may have an ionic conductivity of greater than or equal to aabout 10⁻⁹ to less than or equal to about 10⁻³ S/cm.

In certain other variations, a hydride-based solid electrolyte may be used, such as LiBH₄, LiBH_{4—}LiX (X=Cl, Br or I), LiNH₂, Li₂NH, LiBH₄LiNH₂, Li₃AlH₆. The hydride-based solid state electrolyte may have an ionic conductivity of greater than or equal to aabout 10⁻⁷ to less than or equal to about 10⁴ S/cm. The solid state electrolyte may also be a halide-based solid electrolyte, such as LiI, Li₂CdCl₄, Li₂MgCl₄, Li₂CdI₄, Li₂ZnI₄, Li₃OCl. The halide-based solid state electrolyte may have an ionic conductivity of greater than or equal to aabout 10⁻⁹ to less than or equal to about 10⁻⁵ S/cm. In yet other variations, the solid state electrolyte may be a borate-based solid state electrolyte, such as Li₂B₄O₇, Li₂O—B₂O_{3—}P₂O₅. The sulfide-based solid state electrolyte may have an ionic conductivity of greater than or equal to aabout 10⁻⁷ to less than or equal to about 10⁻⁶ S/cm. Yet other solid state electrolytes may be inorganic solid electrolytes/polymer-based hybride electrolytes or surface modified solid electrolytes. In certain aspects, other specialized solid-state electrolytes may comprise polyvinyl alcohol (PVA)-H₂SO₄; PVA-H₃PO₄; LiCl/PVA; PVAKOH; PVdF-HFP/[EMIM] [Tf₂N]/zeolite, and the like. As appreciated by those of skill in the art, any combination of these solid state electrolytes may be used in the hybrid capacitor materials.

In yet other variations, a quasi-solid state electrolyte may be used, such as an ionic liquid in combinations with metal oxide particles, such as aluminum oxide (Al₂O₃), silicon dioxide (SiO₂), and the like.

In certain variations, a hybrid capacitor material comprises a metal organic framework at greater than or equal to about 1% by mass to less than or equal to about 90% by mass, optionally greater than or equal to about 5% by mass to less than or equal about 50% by mass, and optionally greater than or equal to about 10% by mass to less than or equal about 20% by mass of the metal organic framework. The hybrid capacitor material thus comprises solid state electrolyte at greater than or equal to about 10% by mass to less than or equal to about 99% by mass, optionally greater than or equal to about 50% by mass to less than or equal about 95% by mass, and optionally greater than or equal to about 80% by mass to less than or equal about 90% by mass of the solid state electrolyte. In a variation where the metal organic framework is ZIF-67, the solid electrolyte in the hybrid capacitor material can account for greater than or equal to about 1% to less than or equal to about 40% of the porosity of ZIF-67.

In certain aspects, the present disclosure contemplates a solid-state electrochemical cell that cycles lithium ions. The electrochemical cell comprises an electrolyte in a solid-state or semi-solid state defining a first surface. The electrochemical cell also includes a solid electrode comprising an electroactive material and defining a second surface facing the first surface of the electrolyte. A hybrid capacitor material comprises a metal organic framework intermingled with solid-state electrolyte particles is disposed in at least one of the following: the solid electrode, an interfacial layer disposed between and coextensive with the first surface of the electrolyte and the second surface of the solid electrode, or both in the solid electrode and the interfacial layer.

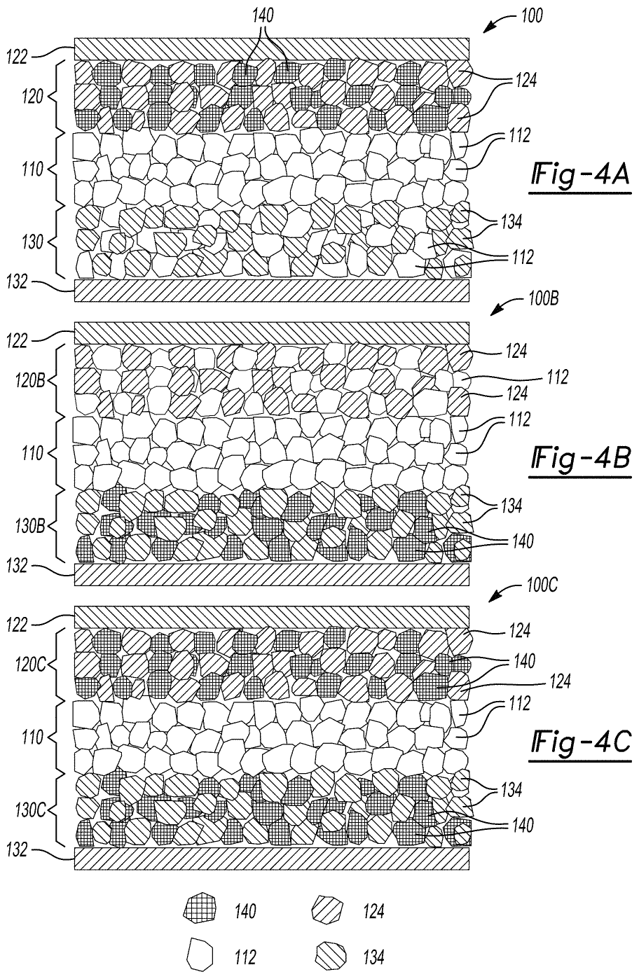

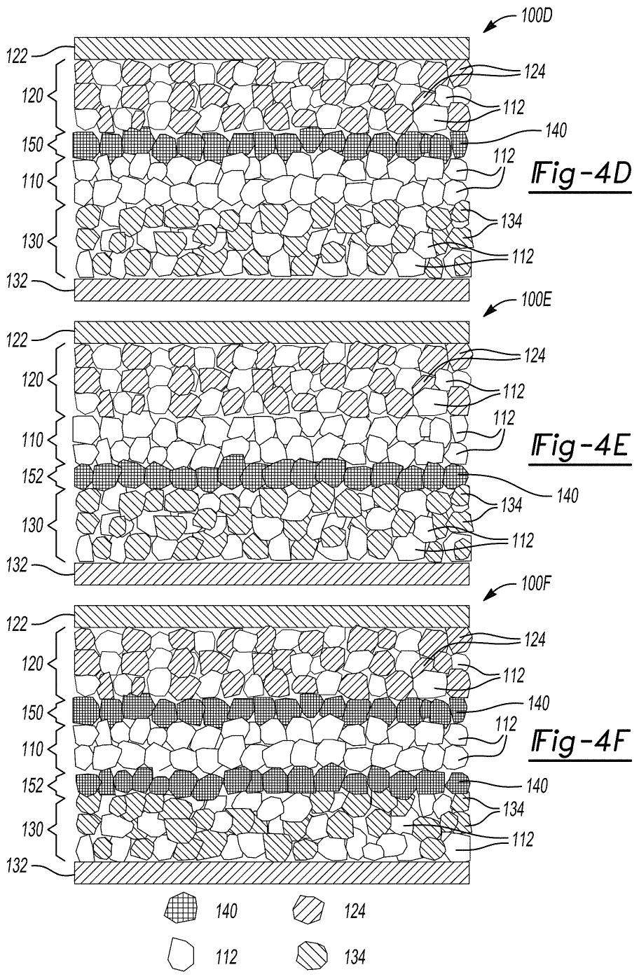

In various aspects, a solid-state electrochemical cell that cycles lithium ions may comprise an electrolyte in a solid-state or semi-solid state defining a first surface. A first solid electrode having a first polarity and comprising an electroactive material defines a second surface. A second solid electrode having a second polarity opposite to the first polarity and comprising an electroactive material defines a third surface. A hybrid capacitor material comprising a metal organic framework intermingled with solid-state electrolyte particles is disposed in at least one of the following: (i) the first solid electrode, (ii) a first interfacial layer disposed between and coextensive with the first surface of the electrolyte and the second surface of the first solid electrode, (iii) the second solid electrode, (iv) a second interfacial layer disposed between and coextensive with the first surface of the electrolyte and the third surface of the second solid electrode, or in any combination of (i)(iv). By way of example, FIGS. 4A-4F show such variations of solid-state electrochemical cells capable of cycling lithium ions prepared in accordance with certain aspects of the present disclosure incorporating a hybrid capacitor material. It should be noted that the contemplated variations are not limited by the configurations shown in FIGS. 4A-4F and that any configuration including select variations shown in FIGS. 4A-4F are likewise contemplated by the present disclosure, for example, one or more interfacial layers and one or more solid-state electrodes having the hybrid capacitor material.

FIG. 4A shows a solid-state electrochemical cell 100 that cycles lithium ions. A solid-state electrolyte layer 110 is disposed in the electrochemical cell 100 and comprises a plurality of solid-state electrolyte particles 112. A first solid electrode 120 having a first polarity, for example a negative electrode or anode, is disposed between a first current collector 122, for example, a negative current collector and the solid-state electrolyte layer 110. The first solid electrode 120 comprises a first electroactive material 124, which may be a negative electroactive material. A second solid electrode 130 having a second polarity opposite to the first polarity, for example, a positive electrode or cathode is disposed on an opposite side of the solid state electrolyte layer 110. The second solid electrode 130 is disposed on a second current collector 132, for example, a positive current collector. The second solid electrode 130 also comprises a second electroactive material 134, which may be a positive electroactive material. The second solid electrode 130 also comprises solid state electrolyte particles 112. It should be noted that while not illustrated in FIG. 4A, the first solid electrode 120 may also contain solid state electrolyte particles 112. In the variation shown in FIG. 4A, a hybrid capacitor material 140 as described above (comprising a metal organic framework (not shown) intermingled with solid-state electrolyte particles (not shown)) is disposed (e.g., for example, homogeneously mixed into) the first solid electrode 120. The hybrid capacitor material 140 particles may be mixed with other components that form the first solid electrode, including the first electroactive material 124 and optionally solid electrolyte particles (e.g., 112), binder particles, electrically conductive particles, and the like, as are well known in the art. In this manner, an electrochemical cell like 100 in FIG. 4A may have a modified negative electrode (first solid electrode 120) with the hybrid capacitor material 140 and thus may provide for rapid adsorption of lithium ions during operation of the electrochemical cell 100.

FIG. 4B shows an alternative version of a solid-state electrochemical cell 100B that cycles lithium ions, where the hybrid capacitor material is incorporated into the second electrode having the second polarity. To the extent that the components are the same as those described above in the context of FIG. 4A in FIGS. 4A-4F, for brevity, unless pertinent to the design shown, they will not be introduced or otherwise discussed again. A first solid electrode 120B has a first polarity, for example a negative electrode or anode, is disposed between a first current collector 122, for example, a negative current collector and the solid-state electrolyte layer 110. The first solid electrode 120 comprises a first electroactive material 124, which may be a negative electroactive material and a plurality of solid state electrolyte particles 112. A second solid electrode 130B having a second polarity opposite to the first polarity, for example, a positive electrode or cathode is disposed on an opposite side of the solid state electrolyte layer 110. The second solid electrode 130B also comprises a second electroactive material 134, which may be a positive electroactive material. In the variation shown in FIG. 4B, a hybrid capacitor material 140 as described above (comprising a metal organic framework (not shown) intermingled with solid-state electrolyte particles (not shown)) is disposed (e.g., for example, homogeneously mixed into) in the second solid electrode 130B. The hybrid capacitor material 140 particles may be mixed with other components that form the second solid electrode 130B, including the second electroactive material 134 and optionally solid electrolyte particles (not shown), binder particles, electrically conductive particles, and the like, as are well known in the art. In this manner, an electrochemical cell like 100B in FIG. 4B may have a modified positive electrode (second solid electrode 130B) with the hybrid capacitor material 140 and thus may provide for rapid desorption of lithium ions during operation of the electrochemical cell 100B.

FIG. 4C shows yet another alternative version of a solid-state electrochemical cell 100C that cycles lithium ions, where the hybrid capacitor material is incorporated into both the first electrode having the first polarity and the second electrode having the second polarity. A first solid electrode 120C has a first polarity, for example a negative electrode or anode, and comprises a first electroactive material 124, which may be a negative electroactive material and optionally a plurality of solid state electrolyte particles (not shown). A second solid electrode 130C having a second polarity opposite to the first polarity, for example, a positive electrode or cathode comprises a second electroactive material 134, which may be a positive electroactive material and optionally a plurality of solid state electrolyte particles (not shown). In the variation shown in FIG. 4C, a hybrid capacitor material 140 as described above (comprising a metal organic framework (not shown) intermingled with solid-state electrolyte particles (not shown)) is disposed (e.g., for example, homogeneously mixed into) in both the first solid electrode 120C and the second solid electrode 130C. The hybrid capacitor material 140 particles may be mixed with other components that form the first and second solid electrodes 120C and 130C, including the first and second electroactive materials 124, 134 and optionally while not shown, solid electrolyte particles, binder particles, electrically conductive particles, and the like, as are well known in the art. In this manner, an electrochemical cell like 100C in FIG. 4C may have a modified negative electrode (first solid electrode 120C) and positive electrode (second solid electrode 130C) both having the hybrid capacitor material 140 incorporated therein and thus may provide for rapid adsorption and desorption of lithium ions during operation of the electrochemical cell 100C.

FIG. 4D shows yet another alternative version of a solid-state electrochemical cell 100D that cycles lithium ions, where the hybrid capacitor material is incorporated into an interfacial layer between the first electrode having the first polarity and the solid state electrolyte. A first solid electrode 120 has a first polarity, for example a negative electrode or anode, is disposed on a first current collector 122, for example, a negative current collector. The first solid electrode 120 comprises a first electroactive material 124, which may be a negative electroactive material and a plurality of solid state electrolyte particles 112. A first interfacial layer 150 is disposed between the first solid electrode 120 and the solid-state electrolyte layer 110. The first interfacial layer 150 comprises the hybrid capacitor material 140 particles. In certain variations, the interfacial layer comprising the hybrid capacitor material is substantially free of any other components than the hybrid capacitor material. The first interfacial layer 150 may have a thickness greater than or equal to about 100 nm to less than or equal to about 500 μm, and in certain aspects, optionally greater than or equal to about 100 nm to less than or equal to about 100 μm, and in certain variations, greater than or equal to about 100 nm to less than or equal to about 50 μm.

A second solid electrode 130 having a second polarity opposite to the first polarity, for example, a positive electrode or cathode is disposed on an opposite side of the solid state electrolyte layer 110. The second solid electrode 130 also comprises a second electroactive material 134, which may be a positive electroactive material, and a plurality of solid state electrolyte particles 112. In the variation of FIG. 4D, an electrochemical cell like 100D has an interlayer comprising the hybrid capacitor material 140 between the negative electrode (first solid electrode 120) and the solid state electrolyte 110 and thus may provide a buffer pool for lithium ions and rapid adsorption of lithium ions during operation of the electrochemical cell 100D.

FIG. 4E shows yet another alternative version of a solid-state electrochemical cell 100E that cycles lithium ions, where the hybrid capacitor material is incorporated into an interfacial layer between the second electrode having the second polarity and the solid state electrolyte. The first solid electrode 120 has a first polarity, for example a negative electrode or anode, and comprises the first electroactive material 124, which may be a negative electroactive material and a plurality of solid state electrolyte particles 112. A second solid electrode 130 having a second polarity opposite to the first polarity, for example, a positive electrode or cathode is disposed on an opposite side of the solid state electrolyte 110. The second solid electrode 130 also comprises a second electroactive material 134, which may be a positive electroactive material, and a plurality of solid state electrolyte particles 112. In the variation of FIG. 4E, a second interfacial layer 152 is disposed between the second solid electrode 130 and the solid-state electrolyte layer 110. The second interfacial layer 152 comprises the hybrid capacitor material 140 particles. The second interfacial layer 152 may have a thickness greater than or equal to about 11 μm to less than or equal to about 500 μm, and in certain aspects, optionally greater than or equal to about 1 μm to less than or equal to about 100 μm. An electrochemical cell 100E having an interlayer comprising the hybrid capacitor material 140 between the positive electrode (second solid electrode 130) and the solid state electrolyte 110, may provide a buffer pool for lithium ions and rapid desorption of lithium ions during operation of the electrochemical cell 100E.

Finally, FIG. 4F shows yet another alternative version of a solid-state electrochemical cell 100F that cycles lithium ions, where the hybrid capacitor material is incorporated into both a first interfacial layer between the first electrode having the first polarity and the electrolyte and a second interfacial layer between the second electrode having the second polarity and the electrolyte. The first solid electrode 120 has a first polarity, for example a negative electrode or anode, and comprises the first electroactive material 124, which may be a negative electroactive material and optionally a plurality of solid state electrolyte particles 112. A second solid electrode 130 having a second polarity opposite to the first polarity, for example, a positive electrode or cathode comprises a second electroactive material 134, which may be a positive electroactive material and optionally a plurality of solid state electrolyte particles 112. In the variation shown in FIG. 4F, a first interfacial layer 150 is disposed between the first solid electrode 120 and the solid-state electrolyte layer 110. The first interfacial layer 150 comprises the hybrid capacitor material 140 particles and may have the same thickness as described above in the context of FIG. 4D. Further, a second interfacial layer 152 is disposed between the second solid electrode 130 and the solid-state electrolyte layer 110. The second interfacial layer 152 comprises the hybrid capacitor material 140 particles and may have the same thickness as described above in the context of FIG. 4E. An electrochemical cell 100E having two interlayers comprising the hybrid capacitor material 140 between the negative electrode (first solid electrode 120) and the solid state electrolyte layer 110 and the positive electrode (second solid electrode 130) and the solid state electrolyte layer 110, may provide two buffer pools for lithium ions (Li⁺ conduction buffer pools that provide a quick ion adsorbing/desorbing) at each solid electrode and thus rapid adsorption and desorption of lithium ions during operation of the electrochemical cell 100F.

In various aspects, as noted above, the plurality of solid-state electrolyte particles 112 may define the solid-state electrolyte layer 110. As appreciated by those of skill in the art, the solid-state electrolyte particles 112 used in the solid-state electrolyte layer 110 may be of a different composition from those used in the first and second solid electrodes or used to form the hybrid capacitor material prepared in accordance with certain aspects of the present disclosure, as discussed above. Notably, the solid-state electrolyte particles used in the solid electrodes may be of a different particle size than the solid state electrolyte particles in the solid-state electrolyte layer, although these may be of the same size and diameter. In certain aspects, the solid-state electrolyte particles 112 used to form the solid-state electrolyte layer 110 comprise a ceramic oxide, such as garnet type LiₐLa_{b}Zr_{c}O_{d} materials, like Li₇La₃Zr₂O₁₂ (LLZO), LiₓLa_{y}TiO₃ where 0<x<1 and 0<y<1 (LLTO), Li₁₊ₓAl_{y}Ti_{2-y}PO₄ where 0<x<1 and 0<y<2 (LATP), Li₂₊₂ₓZn₁₋ₓGeO₄ where 0<x<1 (LISICON), Li₂PO₂N (LIPON), LiₓLa_{2/3-x}TiO₃, Li₁₊ₓAlₓTi₂₋ₓ(PO₄)₃, or sulfides, like Li₁₀GeP₂S₁₂, and combinations thereof, as non-limiting examples. In certain embodiments, the solid-state electrolyte particles 112 optionally comprise a dopant. Solid electrolyte materials may be selected to be stable in the presence of certain electroactive materials, like lithium, such as a garnet-type material, like Li₇La₃Zr₂O (LLZO).

For example, the solid-state electrolyte layer 110 may be in the form of a layer having a thickness greater than or equal to about 1 μm to less than or equal to about 1 mm, and in certain aspects, optionally greater than or equal to about 1 μm to less than or equal to about 100 μm. Such solid-state electrolyte layers 110 after processing into a consolidated form or final state may have an interparticle porosity between the respective solid-state electrolyte particles of less than or equal to about 10 vol. %, optionally less than or equal to about 5 vol. %.

The first (negative) electroactive material forming the first solid electrode may be a lithium host material that is capable of functioning as a negative terminal of a lithium-ion battery. In certain aspects, the first solid electrode may be a solid film comprising lithium metal. In certain variations, the negative electroactive material may be elemental lithium or an alloy of lithium. In other variations, the negative electroactive material forming the negative first solid electrode may be silicon-based, for example, a silicon alloy. In yet other variations, the negative electroactive material may be a carbonaceous material, such as graphite or graphene. In still further variations, the negative electroactive material may comprise one or more negative electroactive materials, such as lithium titanium oxide (Li₄Ti₅O₁₂) and sodium titanium oxide (Na₄Ti₅O₁₂); one or more metal oxides, such as V₂O₅; and metal sulfides, such as FeS.

In certain variations, the negative electrode may include greater than or equal to about 10 wt. % to less than or equal to about 95 wt. %, and in certain aspects, optionally greater than or equal to about 50 wt. % to less than or equal to about 95 wt. %, of the negative solid-state electroactive particles 124 and greater than or equal to about 5 wt. % to less than or equal to about 70 wt. %, and in certain aspects, optionally greater than or equal to about 10 wt. % to less than or equal to about 30 wt. %, of the plurality of solid-state electrolyte particles 112. In alternative aspects, the first solid negative electrode may be a composite type of electrode having a plurality of negative electroactive material particles distributed within a polymer binder matrix with an electrolyte and optional electrically conductive particles.

The negative electrode current collector 122 may be formed from copper (Cu), stainless steel, or any other electrically conductive material known to those of skill in the art.

In lithium-ion batteries, lithium intercalates and/or alloys in the electrode active materials, thus, the second (positive) solid electrode may be formed from a lithium-based second electroactive material that can undergo lithium cycling (e.g., intercalation and deintercalation) while functioning as the positive terminal of the battery or electrochemical cell. For example, while not limiting, in certain variations, the first positive solid electrode may include the plurality of positive solid-state electroactive particles mixed with solid-state electrolyte particles. However, it should be noted that the second positive solid electrode is not limited to the embodiments shown.

In certain instances, the second positive solid state electrode is a composite comprising a mixture of the positive solid-state electroactive particles and solid-state electrolyte particles (notably, which may be of a different particle size than the solid state electrolyte particles in the solid-state electrolyte layer, although these may be of the same size and diameter). For example, the positive electrode may include greater than or equal to about 10 wt. % to less than or equal to about 95 wt. %, and in certain aspects, optionally greater than or equal to about 50 wt. % to less than or equal to about 95 wt. %, of the positive solid-state electroactive particles 134 and greater than or equal to about 5 wt. % to less than or equal to about 70 wt. %, and in certain aspects, optionally greater than or equal to about 10 wt. % to less than or equal to about 30 wt. %, of the plurality of solid-state electrolyte particles 112. Such positive electrodes may have an interparticle porosity between the positive solid-state electroactive particles and/or the solid-state electrolyte particles that is less than or equal to about 30 vol. %, optionally less than or equal to about 20 vol. %. As noted above, in certain variations, the plurality of solid-state electrolyte particles may be the same as or different from the solid-state electrolyte particles in the solid-state electrolyte layer 110, whether by composition or size.

The second solid-state (positive) electrode may include a variety of distinct positive electroactive materials that can cycle lithium. In various aspects, the second solid-state electrode 130 may include a second (positive) electroactive material 134 that is one of a layered-oxide cathode, a spinel cathode, or a polyanion cathode. For example, in the instances of a layered-oxide cathode (e.g., rock salt layered oxides), the positive solid-state electroactive particles may comprise one or more positive electroactive materials selected from LiCoO₂, LiNiₓMn_{y}Co_{1-x-y}O₂ (where 0≤x≤1 and 0≤y≤1), LiNiₓMn₁₋ₓO₂ (where 0≤x≤1), and Li₁₊ₓMO₂ (where 0≤x≤1) for solid-state lithium-ion batteries. The spinel cathode may include one or more positive electroactive materials, such as LiMn₂O₄ and LiNixMn_{1.5}O₄ for lithium-ion batteries. The polyanion cation may include, for example, a phosphate such as LiFePO₄, LiVPO₄, LiV₂(PO₄)₃, Li₂FePO₄F, Li₃Fe₃(PO₄)₄, or Li₃V₂(PO₄)F₃ for lithium-ion batteries; and/or a silicate such as LiFeSiO4. In this fashion, in various aspects, the positive solid-state electroactive particles may comprise one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where ₀≤x≤₁), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In another aspect, the second (positive) solid-state electrode 130 may include additional materials that may be appropriate to provide a desired voltage between the second solid-state (positive) electrode 130 and the first solid-state (negative) electrode may be used.

In certain variations, where the first (negative) or second (positive) solid-state electroactive particles 124, 134 are present in the first solid-state (negative) electrode 120 or the second solid-state (positive) electrode 130, the first (negative) or second (positive) solid-state electroactive particles 124, 134 may be optionally intermingled with one or more electrically conductive materials (not shown) that provide an electron conduction path and/or at least one polymeric binder material (not shown) that improves the structural integrity of the first solid electrode 120 or second solid electrode 130. Electrically conductive materials may include, for example, carbon-based materials, powdered nickel or other metal particles, or a conductive polymer. Carbon-based materials may include, for example, particles of graphite, acetylene black (such as KETCHEN™ black or DENKA™ black), carbon fibers and nanotubes, graphene, and the like. Examples of a conductive polymer may include polyaniline, polythiophene, polyacetylene, polypyrrole, and the like. In certain aspects, mixtures of the conductive materials may be used. The solid-state electroactive particles 124, 134 may be optionally intermingled with binders, like polyvinylidene difluoride (PVDF), polytetrafluoroethylene (PTFE), ethylene propylene diene monomer (EPDM) rubber, nitrile butadiene rubber (NBR), styrene-butadiene rubber (SBR), lithium polyacrylate (LiPAA), and/or sodium polyacrylate (NaPAA) binders.

The first solid-state (negative) electrode 120 or the second solid-state (positive) electrode 130 may include greater than or equal to about 0 wt. % to less than or equal to about 25 wt. %, optionally greater than or equal to about 0 wt. % to less than or equal to about 10 wt. %, and in certain aspects, optionally greater than or equal to about 0 wt. % to less than or equal to about 5 wt. % of the one or more electrically conductive additives and greater than or equal to about 0 wt. % to less than or equal to about 20 wt. %, optionally greater than or equal to about 0 wt. % to less than or equal to about 10 wt. %, and in certain aspects, optionally greater than or equal to about 0 wt. % to less than or equal to about 5 wt. % of the one or more binders.

The second (positive) electrode current collector 132 may be formed from aluminum (Al) or any other electrically conductive material known to those of skill in the art.

The present disclosure also contemplates a method of making a hybrid capacitor material for a solid-state electrochemical cell that cycles lithium ions. The method may comprise heating a precursor comprising a metal organic framework material, a solid-state electrolyte material and solvent to a temperature of greater than or equal to about 20 to less than or equal to about 85° C. for a period of greater than or equal to about 10 minutes to less than or equal to about 10 hours. In certain variations, the temperature is about 80° C. and the period of heating may be about 6 hours. The metal organic framework material and the solid-state electrolyte material may be any of those described above. The solvent may be an alcohol, such as ethanol (EtOH), methanol (MeOH), tetrahydrofuran (THF), acetonitrile (ACN), ethyl acetate (EA), dimethylformamide (NMF), dimethyl ether (DME), dimethyl carbonate (DMC), EP, hexane, combinations thereof and the like. In certain variations, the solvent is non-aqueous and does not contain water.

In this particular solution-based preparation method, the solid-state electrolyte is substantially dissolved or soluble in the solvent(s) listed above. In certain aspects, solid-state electrolytes that can be dissolved in the solvent described above include, by way of example: Li₁₀GeP₂S₁₂, Li₂S—P₂S₅, Li₂S—P₂S_{5—}MSx, Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂Si_{1.700.3}, Li₆PS₅X (lithium argyrodite, where X=Cl, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, perovskite type (Li₃xLa_{2/3-x}TiO₃), NASICON type (LiTi₂(PO₄)₃), Li₁₊ₓAlₓTi₂₋ₓ(PO4)3 (LATP), Li₁₊ₓAlₓGe₂₋ₓ (PO₄)₃ (LAGP), Li₁₊ₓYₓZr₂₋ₓ(PO₄)₃ (LYZP), LISICON type (Li₁₄Zn(GeO₄)₄), garnet type (Li_{6.5}La₃Zr_{1.75}Te_{0.25}O₁₂), and combinations thereof and the metal organic framework of the hybrid capacitor material is selected from the group consisting of: ZIF-2 and ZIF-3 (Zn₂(Im)₄), ZIF-4 and ZIF-6 (Zn(Im)₂), ZIF-5 (Zn₃In₂(Im)₁₂), ZIF-11 and ZIF-7 (Zn(bIm)₂) (C₇H₆N₂.Zn.H₂O), ZIF-8 (C₈H₁₀N₄Zn), ZIF-9 (C₇H₆N₂.Co.H₂O), ZIF-11 (Zn[C₇H₅N₂]₂), ZIF-14 (Zn(eIm)₂), ZIF-67 (C₈H₁₀N₄Co), ZIF-68 (C_{7.06}H_{4.94}N_{3.53}O_{1.59}Zn_{0.71}), ZIF-90 (C₄₈H₃₆N₂₄O₁₂Zn₆), IR-MOF ((Zn4O)⁶⁺), IR-MOF-16 (Zn4O(TPDC)₃, TPDC=terphenyldicarboxylate, IRMOF-1 (Zn₄O(BDC)₃), IRMOF-3 (Zn4O(BDC-NH₂)₃), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg₂(DOT)), IRMOF-74-II (Mg₂(DH₂PhDC)), IRMOF-74-III (Mg₂(DH₃PhDC)), HKUST-1 ([Cu₃(C₉H₃O₆)₂]ₙ), MIL-53 (Fe(OH)(BDC)), MIL-100 (Fe₃F(H₂O)₂O[(C₆H₃)-(CO₂)₃]₂.nH₂O), MIL-101 [Cr₃(O)ₓ(bdc)₃(H₂O)₂] (bdc=benzene-1,4-dicarboxylate, X=OH or F), UiO (with Zr₆O₄(OH)₄), UIO-66 (Zr₂₄O₁₂₀C₁₉₂H₉₆N₂₄), UIO-67 ([Zr₆O₄(OH)₄—. (bpdc)₆] [bpdc=biphenyldicarboxylate, O₂C(C₆H₄)₂CO₂]), UIO-68 (Zr₆O₄(OH)₄(C₂₀H₁₀O₆)₆(C₃H₇NO)(CH₂Cl₂)₃), CPL-1 ([CU₂(pZdC)₂(L)]n, C₂₆H₈N₆O₈Cu₂), CPL-2(C₂₂H₁₂N₆O₈Cu₂), CPL-5(C₂₄H₁₄N₆O₈Cu₂), biomolecular ligands and CD-MOFs, PCN-14 (C₂₇₀H₁₆₂Cu₁₈O₉₀), covalent organic frameworks (COFs), and combinations thereof.

After the first heat treatment, the mixture of treated precursor is subjected to an optional second process for removing the solvent, for example, vacuum drying where the precursor is heated under negative (sub-atmospheric) pressures. Thus, the solvent may be removed to form a hybrid capacitor material comprising the metal organic framework having the solid-state electrolyte associated therewith. By way of example, the vacuum drying of the precursor may be at a temperature of greater than or equal to about 100° C. to less than or equal to about 300° C. for a period of greater than or equal to about 30 minutes to less than or equal to about 48 hours. In one variation, the vacuum drying is conducted at the temperature of about 150° C. for about 20 hours.

As noted above, the present disclosure contemplates forming two distinct variations of a hybrid capacitor material comprising a metal organic framework and a solid-state electrolyte. The embodiment of the hybrid capacitor formed depends on the relative particle size diameter of at least a portion of solid state electrolyte particles versus an average particle size diameter of the metal organic framework particles. More specifically, where the average particle size diameter and/or average pore size of the metal organic framework particles is greater than the average particle size diameter of the solid-state electrolyte particles, the solid-state electrolyte may coat a surface of the metal organic framework and further may be at least partially disposed inside pores of the metal organic framework. In this variation, the solid state electrolyte particles may be considered to be wrapped about the exterior surface(s) of the metal organic framework and some of the solid-state electrolyte particles may further penetrate into the pores of the metal organic framework.

Where the average particle size diameter and/or average pore size of the solid-state electrolyte particles is greater than the average particle size diameter of the metal organic framework particles, the metal organic framework particles may coat a surface of the solid-state electrolyte particles. In this manner, the metal organic framework is at least partially disposed on and covering surfaces of the solid-state electrolyte particles.

In one example of a method of fabrication, a precursor includes 50 mg of ZIF-67 metal organic framework (MOF), 0.09 mg/ml of Li₆PS₅Cl (LPSCl), in ethanol solvent. The precursor mixture is heated in a sealed container for 6 hours at 80° C. Then the precursor is vacuum dried at 150° C. for 20 hours to fully remove the solvent and forms a hybrid capacitor material of ZIF-67 and LPSCl where the LPSCl coats the exterior surfaces of the ZIF-67 and penetrates into a portion of the internal pores of the ZIF-67.

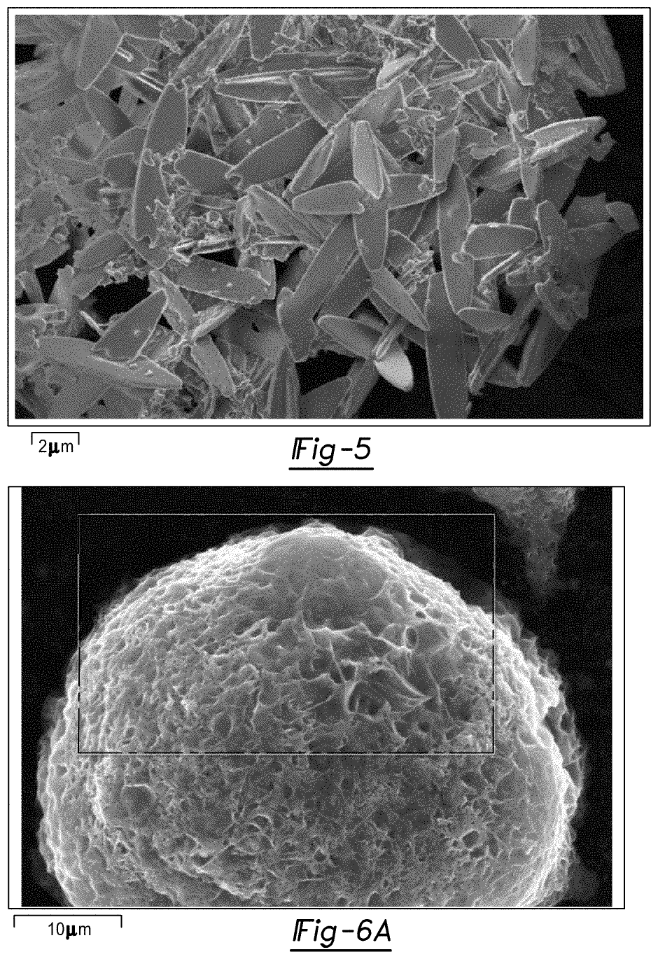

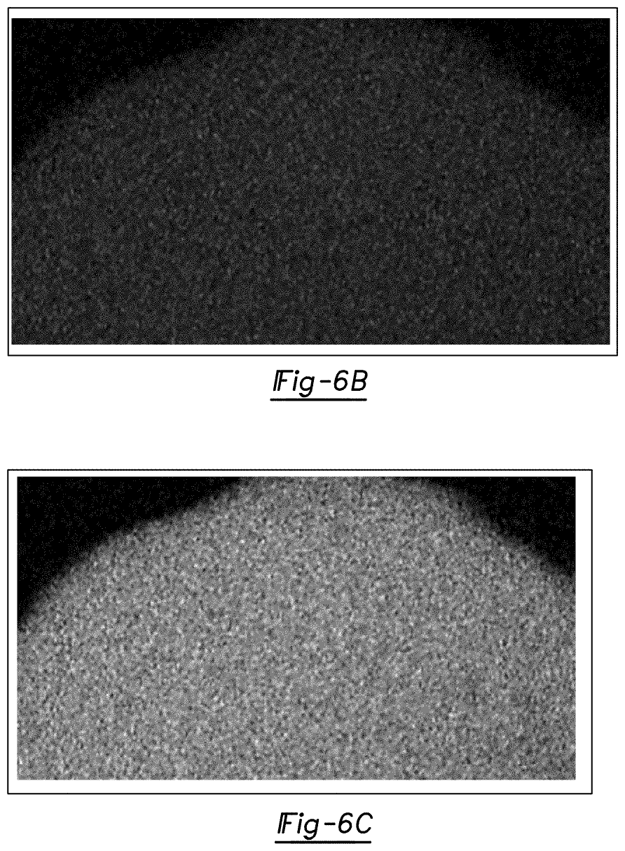

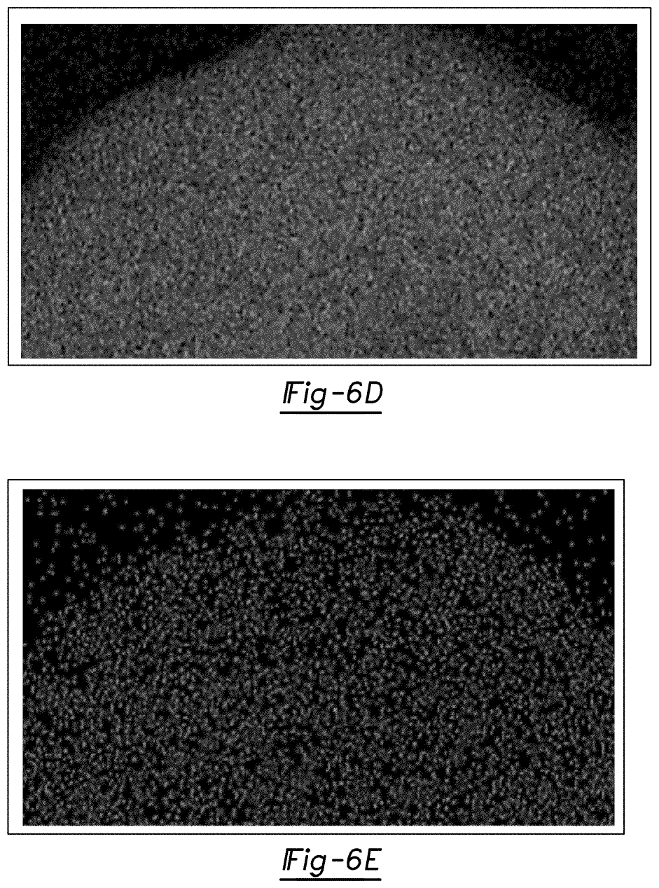

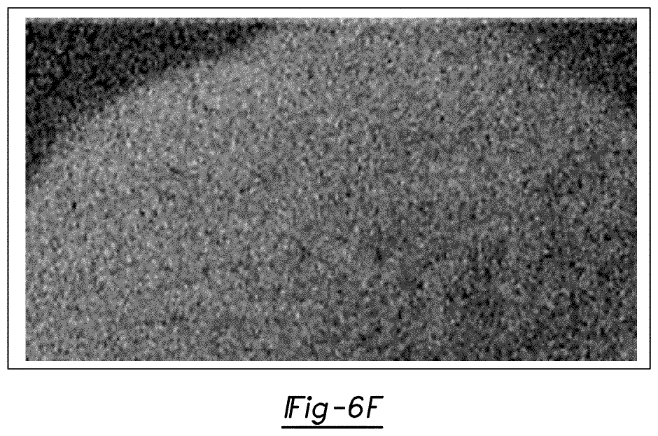

FIG. 5 shows an SEM of a precursor of a metal organic framework (ZIF-67). FIGS. 6A-6F show SEM images of a hybrid capacitor material prepared in accordance with certain aspects of the present disclosure comprising a metal organic framework (ZIF-67) intermingled with solid-state LPSCl electrolyte particles and a bare metal organic framework (ZIF-67) respectively. Compared with the morphology of the bare metal organic framework (ZIF-67) in FIG. 5, the hybrid capacitor material in FIGS. 6A-6F comprising a metal organic framework (ZIF-67) intermingled with solid-state LPSCl electrolyte particles changes. The solid-state LPSCl electrolyte particles uniformly cover the surface of the metal organic framework (ZIF-67).

FIGS. 6B-6F show EDS mapping of different elements respectively namely phosphorus (P) (FIG. 6B), sulfur (S) (FIG. 6C), chlorine (Cl) (FIG. 6D), cobalt (Co) (FIG. 6E), and oxygen (O) (FIG. 6F). The EDS mapping of phosphorus (P) (FIG. 6B), sulfur (S), (FIG. 6C), chlorine (Cl) (FIG. 6C) elements coming from the solid-state LPSCl electrolyte particles further shows the uniformity of their distribution on the exterior surface and inside pores of the metal organic framework (ZIF-67). The ionic conductivity of a solid-state electrolyte (LPSCl) is compared to that of the hybrid capacitor material prepared in accordance with certain aspects of the present disclosure (here the ZIF-67 and LPSCl hybrid capacitor material) and shows that ionic conductivity is increased by 1.7 fold.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A solid-state electrochemical cell that cycles lithium ions, the electrochemical cell comprising:
an electrolyte layer in a solid-state or semi-solid state defining a first surface;
a solid electrode comprising an electroactive material and defining a second surface; and
a hybrid capacitor material comprising a metal organic framework intermingled with solid-state electrolyte particles disposed in at least one of the following: the solid electrode, an interfacial layer disposed between the first surface of the electrolyte layer and the second surface of the solid electrode, or both in the solid electrode and the interfacial layer.

2. The solid-state electrochemical cell of claim 1, wherein the solid electrode is a positive electrode and comprises a positive electroactive material selected from the group consisting of: LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)_{4,}Li₃V₂(PO₄)F₃, LiFeSiO₄, and combinations thereof.

3. The solid-state electrochemical cell of claim 1, wherein the solid electrode is a negative electrode and comprises a negative electroactive material selected from the group consisting of: lithium metal, silicon, silicon oxide, silicon alloys, graphite, graphene, lithium titanium oxide (Li₄Ti₅O₁₂) and sodium titanium oxide (Na₄Ti₅O₁₂); vanadium oxide (V₂O₅), and iron sulfide (FeS), and combinations thereof.

4. The solid-state electrochemical cell of claim 1, wherein the solid-state electrolyte layer comprises a material selected from the group consisting of: Li₇La₃Zr₂O₁₂ (LLZO), LiₓLa_{y}TiO₃ where 0≤x≤1 and 0≤y≤1 (LLTO), Li₁₊ₓAl_{y}Ti_{2-y}PO₄ where 0≤x≤1 and 0≤y≤2 (LATP), Li₂₊₂ₓZn₁₋ₓGeO₄ where 0<x<1 (LISICON), Li₂PO₂N (UPON), LiₓLa_{2/3-x}TiO₃, Li₁₊ₓAlₓTi₂₋ₓ(PO₄)₃, Li₁₀GeP₂S₁₂, Li₂S—P₂S₅, Li₂S—P₂S₅MSₓ, Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, Li₆PS₅X (lithium argyrodite, where X=Cl, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.8}iSn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, perovskite type (Li₃ₓLa_{2/3-x}TiO₃), NASICON type (LiTi₂(PO₄)₃), Li₁₊ₓAlₓTi₂₋ₓ(PO₄)₃ (LATP), Li₁₊ₓAlₓGe₂₋ₓ (PO₄)₃ (LAGP), Li₁₊ₓYₓZr₂₋ₓ(PO₄)₃ (LYZP), LISICON type (Li₁₄Zn(GeO₄)₄), garnet type (Li_{6.5}La₃Zr_{1.75}Te_{0.25}O₁₂), Li₃N, Li₇PN₄, LiSi₂N₃, LiBH₄, LiBH_{4—}LiX (X=Cl, Br or I), LiNH₂, Li₂NH, LiBH₄LiNH₂, Li₃AlH₆, LiI, Li₂CdCl₄, Li₂MgCl₄, Li₂CdI₄, Li₂ZnI₄, Li₃OCl, Li₂B₄O₇, Li₂O—B₂O_{3—}P₂O₅, polyvinyl alcohol (PVA)-H₂SO₄; PVAH₃PO₄; LiCl/PVA; PVAKOH; PVdF-HFP/[EMIM] [Tf₂N]/zeolite, a polymer host selected from include polyethylene oxide (PEO) or polyethylene glycol (PEG), polypropylene oxide (PPO), polymethylmethacrylate (PMMA), polyacrylonitrile (PAN), polyvinylidene fluoride (PVDF), polyvinylidene fluoride-hexafluoropropylene (PVDF-HFP), polyvinyl chloride (PVC) and a lithium salt, an ionic liquid in combination with a metal oxide particle selected from aluminum oxide (Al₂O₃), silicon dioxide (SiO₂), and combinations thereof.

5. The solid-state electrochemical cell of claim 1, wherein the interfacial layer has a thickness of greater than or equal to about 100 nm to less than or equal to about 50 micrometers.

6. The solid-state electrochemical cell of claim 1, wherein the metal organic framework is selected from the group consisting of: ZIF-2 and ZIF-3 (Zn₂(Im)₄), ZIF-4 and ZIF-6 (Zn(Im)₂), ZIF-5 (Zn₃In₂(Im)₁₂), ZIF-11 and ZIF-7 (Zn(bIm)₂) (C₇H₆N₂.Zn.H₂O), ZIF-8 (C₈H₁₀N₄Zn), ZIF-9 (C₇H₆N₂.Co.H₂O), ZIF-11 (Zn[C₇HSN₂]₂), ZIF-14 (Zn(eIm)₂), ZIF-67 (C₈H₁₀N₄Co), ZIF-68 (C_{7.06}H_{4.94}N_{3.53}O_{1.59}Zn_{0.71}), ZIF-90 (C₄₈H₃₆N₂₄O₁₂Zn₆), IR-MOF ((Zn₄O)^{6±}), IR-MOF-16 (Zn₄O(TPDC)₃, TPDC=terphenyldicarboxylate, IRMOF-1 (Zn₄O(BDC)₃), IRMOF-3 (Zn₄O(BDC-NH₂)3), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg₂(DOT)), IRMOF-74-I (Mg₂(DH₂PhDC)), IRMOF-74-III (Mg₂(DH₃PhDC)), HKUST-1 ([Cu₃(C₉H₃O₆)₂]ₙ), MIL-53 (Fe(OH)(BDC)), MIL-100 (Fe₃F(H₂O)₂O[(C₆H₃)-(CO₂)₃]₂.nH₂O), MIL-101 [Cr₃(O)x(bdc)₃(H₂O)₂] (bdc=benzene-1,4-dicarboxylate, X=OH or F)), UiO (with Zr₆O₄(OH)₄), UIO-66 (Zr₂₄O₁₂₀C₁₉₂H₉₆N₂₄), UIO-67 ([Zr₆O₄(OH)₄—. (bpdc)₆] [bpdc=biphenyldicarboxylate, O₂C(C₆H₄)₂CO₂]), UIO-68 (Zr₆O₄(OH)₄(C₂₀H₁₀O₆)₆(C₃H₇NO)(CH₂Cl₂)₃), CPL-1 ([CU₂(₁)ZdC)₂(L)]ₙ, C₁₆H₈N₆O₈Cu₂), CPL-2(C₂₂H₁₂N₆O₈Cu₂), CPL-5(C₂₄Hi₄N₆O₈Cu₂), biomolecular ligands and CD-MOFs, PCN-14 (C₂₇₀H₆₂Cu₁₈O₉₀), covalent organic frameworks (COFs), and combinations thereof.

7. The solid-state electrochemical cell of claim 1, wherein the electrode is a negative electrode.

8. The solid-state electrochemical cell of claim 1, wherein the metal organic framework is at least partially disposed on and covering exterior surfaces of the solid-state electrolyte particles of the hybrid capacitor material.

9. The solid-state electrochemical cell of claim 1, wherein the solid-state electrolyte is at least partially disposed on and covering exterior surfaces of the metal organic framework of the hybrid capacitor material.

10. The solid-state electrochemical cell of claim 9, wherein the solid-state electrolyte is at least partially disposed inside pores of the metal organic framework of the hybrid capacitor material.

11. A solid-state electrochemical cell that cycles lithium ions, the electrochemical cell comprising:
an electrolyte layer in a solid-state or semi-solid state;
a first solid electrode having a first polarity and comprising a first electroactive material;
a second solid electrode having a second polarity opposite to the first polarity and comprising a second electroactive material; and
a hybrid capacitor material comprising a metal organic framework intermingled with solid-state electrolyte particles is disposed in at least one of the following: (i) the first solid electrode, (ii) a first interfacial layer disposed between the electrolyte layer and the first solid electrode, (iii) the second solid electrode, (iv) a second interfacial layer disposed between the electrolyte layer and the second solid electrode, or in any combination of (i)-(iv).

12. The solid-state electrochemical cell of claim 11, wherein the first solid electrode is a negative electrode and the first electroactive material comprises a negative electroactive material selected from the group consisting of: lithium metal, silicon, silicon oxide, silicon alloys, graphite, graphene, lithium titanium oxide (Li₄Ti₅O₁₂) and sodium titanium oxide (Na₄Ti₅O₁₂); vanadium oxide (V₂O₅), and iron sulfide (FeS), and combinations thereof, and the second solid electrode is a positive electrode and the second electroactive material comprises a positive electroactive material selected from the group consisting of: LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof.

13. The solid-state electrochemical cell of claim 11, wherein the solid-state electrolyte particles of the hybrid capacitor material comprise a material selected from the group consisting of: Li₇La₃Zr₂O₁₂ (LLZO), LiₓLa_{y}TiO₃ where 0<x<1 and 0<y<1 (LLTO), Li₁₊ₓAl_{y}Ti_{2-y}PO₄ where 0<x<1 and 0<y<2 (LATP), Li₂₊₂ₓZn₁₋ₓGeO₄ where 0<x<1 (LISICON), Li₂PO₂N (LIPON), LiₓLa_{2/3-x}TiO₃, Li₁₊ₓAlₓTi₃₋ₓ(PO₄)₃, Li₁₀GeP₂S₁₂, Li₂S—P₂S₅, Li₂S—P₂S_{5—}MSx, Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, Li₆PS₅X (lithium argyrodite, where X=Cl, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, perovskite type (Li₃ₓLa_{2/3-x}TiO₃), NASICON type (LiTi₂(PO₄)₃), Li₁₊ₓAlₓTi₂₋ₓ(PO₄)₃ (LATP), Li₁₊ₓAlₓGe₂₋ₓ (PO₄)₃ (LAGP), Li₁₊ₓYₓZr₂₋ₓ(PO₄)₃ (LYZP), LISICON type (Li₁₄Zn(GeO₄)₄), garnet type (Li₆₅La₃Zr_{1.75}Te_{0.25}O₁₂), Li₃N, Li₇PN₄, LiSi₂N₃, LiBH₄, LiBH_{4—}LiX (X=Cl, Br or I), LiNH₂, Li₂NH, LiBH_{4—}LiNH₂, Li₃AlH₆, LiI, Li₂CdCl₄, Li₂MgCl₄, Li₂CdI₄, Li₂ZnI₄, Li₃OCl, Li₂B₄O₇, Li₂O—B₂O_{3—}P₂O₅, polyvinyl alcohol (PVA)-H₂SO₄; PVA-H₃PO₄; LiCl/PVA; PVA-KOH; PVdF-HFP/[EMIM] [Tf₂N]/zeolite, a polymer host selected from include polyethylene oxide (PEO) or polyethylene glycol (PEG), polypropylene oxide (PPO), polymethylmethacrylate (PMMA), polyacrylonitrile (PAN), polyvinylidene fluoride (PVDF), polyvinylidene fluoride-hexafluoropropylene (PVDF-HFP), polyvinyl chloride (PVC) and a lithium salt, an ionic liquid in combination with a metal oxide particle selected from aluminum oxide (Al₂O₃), silicon dioxide (SiO₂), and combinations thereof.

14. The solid-state electrochemical cell of claim 11, wherein the metal organic framework of the hybrid capacitor material is selected from the group consisting of: ZIF-2 and ZIF-3 (Zn₂(Im)₄), ZIF-4 and ZIF-6 (Zn(Im)₂), ZIF-5 (Zn₃In₂(Im)₁₂), ZIF-11 and ZIF-7 (Zn(bIm)₂) (C₇H₆N₂-Zn-H₂O), ZIF-8 (C₈H₁oN₄Zn), ZIF-9 (C₇H₆N₂-Co H₂O), ZIF-11 (Zn[C₇HSN_{2]2}), ZIF-14 (Zn(eIm)₂), ZIF-67 (C₈H₁₀N₄Co), ZIF-68 (C_{7.06}H_{4.94}N_{3.5301.59}Zn_{0.71}), ZIF-90 (C₄₈H₃₆N₂₄₀₁₂Zn₆), IR-MOF ((Zn₄O)₆₊), IR-MOF-16 (Zn₄O(TPDC)₃, TPDC=terphenyldicarboxylate, IRMOF-1 (Zn₄O(BDC)₃), IRMOF-3 (Zn₄O(BDC-NH₂)₃), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg₂(DOT)), IRMOF-74-II (Mg₂(DH₂PhDC)), IRMOF-74-III (Mg₂(DH₃PhDC)), HKUST-1 ([Cu₃(C₉H₃O₆)₂]ₙ), MIL-53 (Fe(OH)(BDC)), MIL-100 (Fe₃F(H₂O)₂O[(C₆H₃)-(CO₂)₃]₂.nH₂O), MIL-101 [Cr₃(O)x(bdc)₃(H₂O)₂] (bdc=benzene-1,4-dicarboxylate, X=OH or F)), UiO (with Zr₆O₄(OH)₄), UIO-66 (Zr₂₄O₁₂₀Cl₉₂H₉₆N₂₄), UIO-67 ([Zr₆O₄(OH)₄—. (bpdc)₆] [bpdc=biphenyldicarboxylate, O₂C(C₆H₄)₂CO₂]), UIO-68 (Zr₆O₄(OH)₄(C₂₀H₁₀O₆)₆(C₃H₇NO)(CH₂Cl₂)₃), CPL-1 ([Cu₂(pzdc)₂(L)]ₙ, Cl₆H₈N₆O₈Cu₂), CPL-2(C₂₂H₁₂N₆O₈Cu₂), CPL-5(C₂₄H₁₄N₆O₈Cu₂), biomolecular ligands and CD-MOFs, PCN-14 (C₂₇₀H₁₆₂Cu₁₈O₉₀), covalent organic frameworks (COFs), and combinations thereof.

15. A method of making a hybrid capacitor material for a solid-state electrochemical cell that cycles lithium ions, the method comprising:
heating a precursor comprising a metal organic framework material, a solid-state electrolyte material and solvent to a temperature of greater than or equal to about 20 to less than or equal to about 85° C. for a period of greater than or equal to about 10 minutes to less than or equal to about 10 hours; and
removing solvent to form a hybrid capacitor material comprising the metal organic framework having the solid-state electrolyte associated therewith.

16. The method of claim 15, wherein after the heating the precursor, the removing the solvent comprises vacuum drying the precursor at a temperature of greater than or equal to about 100° C. to less than or equal to about 300° C. for a period of greater than or equal to about 30 minutes to less than or equal to about 48 hours.

17. The method of claim 16, wherein the heating the precursor is to a temperature of about 80° C. for a period of greater than or equal to about 6 hours; and the vacuum drying is conducted at the temperature of about 150° C. for about 20 hours.

18. The method of claim 15, wherein the metal organic framework is at least partially disposed on and covering exterior surfaces of the solid-state electrolyte particles.

19. The method of claim 15, wherein the solid-state electrolyte is at least partially disposed on and covering surfaces of the exterior surfaces of the metal organic framework and the solid-state electrolyte is at least partially disposed inside pores of the metal organic framework.

20. The method of claim 15, wherein the solid-state electrolyte of the hybrid capacitor material is selected from the group consisting of: Li₁₀GeP₂S₁₂, Li₂S—P₂S₅, Li₂S—P₂S_{5—}MSₓ, Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, Li₆PS₅X (lithium argyrodite, where X=Cl, Br, or I), Li_{9.54}Si_{1.74}P_{1.44}S_{11.7}Cl_{0.3}, Li_{9.6}P₃S₁₂, Li₇P₃S₁₁, Li₉P₃S₉O_{3,}Li_{10.35}Ge_{1.35}P_{1.65}S₁₂, Li_{10.35}Si_{1.35}P_{1.65}S₁₂, Li_{9.8}iSno.₈₁P_{2.19}S₁₂, Li₁₀(Si_{0.5}Ge_{0.5})P₂S₁₂, Li₁₀(Ge_{0.5}Sn_{0.5})P₂S₁₂, Li₁₀(Sia₅Sn_{0.5})P₂S₁₂, perovskite type (Li₃ₓLa_{2/3-x}TiO₃), NASICON type (LiTi₂(PO₄)₃), Li₁₊ₓAlₓTi₂₋ₓ(PO₄)₃ (LATP), Li₁₊ₓAlₓGe₂₋ₓ (PO₄)₃ (LAGP), Li₁₊ₓYₓZr₂₋ₓ(PO₄)₃ (LYZP), LISICON type (Li₁₄Zn(GeO₄)₄), garnet type (Li_{6.5}La₃Zr_{1.75}Te_{0.25}O₁₂), and combinations thereof and the metal organic framework of the hybrid capacitor material is selected from the group consisting of: ZIF-2 and ZIF-3 (Zn₂(Im)₄), ZIF-4 and ZIF-6 (Zn(Im)₂), ZIF-5 (Zn₃In₂(Im)₁₂), ZIF-11 and ZIF-7 (Zn(bIm)₂) (C₇H₆N₂—Zn—H₂O), ZIF-8 (C₈H₁₀N₄Zn), ZIF-9 (C₇H₆N₂.Co.H₂O), ZIF-11 (Zn[C₇H₅N₂]₂), ZIF-14 (Zn(eIm)₂), ZIF-67 (C₈H₁₀N₄Co), ZIF-68 (C_{7.06}H_{4.94}N_{3.53}O_{1.59}Zn_{0.71}), ZIF-90 (C₄₈H₃₆N₂₄O₁₂Zn₆), IR-MOF ((Zn₄O)⁶⁺), IR-MOF-16 (Zn₄O(TPDC)₃, TPDC=terphenyldicarboxylate, IRMOF-1 (Zn₄O(BDC)₃), IRMOF-3 (Zn₄O(BDC-NH₂)₃), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg₂(DOT)), IRMOF-74-II (Mg₂(DH₂PhDC)), IRMOF-74-III (Mg₂(DH₃PhDC)), HKUST-1 ([Cu₃(C₉H₃O₆)₂]ₙ), MIL-53 (Fe(OH)(BDC)), MIL-100 (Fe₃F(H₂O)₂O[(C₆H₃)-(CO₂)₃]₂.nH₂O), MIL-101 [Cr₃(O)_{X}(bdc)₃(H₂O)₂] (bdc=benzene-1,4-dicarboxylate, X=OH or F)), UiO (with Zr₆O₄(OH)₄), UIO-66 (Zr₂₄O₁₂₀C₁₉₂H₉₆N₂₄), UIO-67 ([Zr₆O₄(OH)₄—. (bpdc)₆] [bpdc=biphenyldicarboxylate, O₂C(C₆H₄)₂CO₂]), UIO-68 (Zr₆O₄(OH)₄(C₂₀H₁₀O₆)₆(C₃H₇NO)(CH₂Cl₂)3), CPL-1 ([Cu₂(pzdc)₂(L)]ₙ, Cl₆H₈N₆O₈Cu₂), CPL-2(C22H12N6O8Cu2), CPL-5(C₂₄H₁₄N₆O₈Cu₂), biomolecular ligands and CD-MOFs, PCN-14 (C₂₇₀H₁₆₂Cu₁₈O₉₀), covalent organic frameworks (COFs), and combinations thereof.
